(19) United States
(12) Patent Application Publication
(10) Pub. No.: US 2011/0162379 A1
(43) Pub. Date: Jul. 7, 2011

(54) APPARATUS AND METHOD FOR SUPPLYING FUEL

(75) Inventors: ABINASH BARUAH, BANGALORE (IN); ANAND PRAFULCHANDRA DESAI, BANGALORE (IN)

(73) Assignee: GENERAL ELECTRIC COMPANY, SCHENECTADY, NY (US)

(21) Appl. No.: 12/652,936

(22) Filed: Jan. 6, 2010

(51) Int. Cl. F02C 3/20

(52) U.S. Cl. 60/772; 60/39.463; 60/746

(57) ABSTRACT

A nozzle includes first, second, and third ports each angled to direct a first, second, and third fluid in a first, second, and third rotational direction, respectively. The first, second, and third fluids are selected from the group consisting of a first fuel, a second fuel, a diluent, and a compressed working fluid. A method for supplying fuel through a nozzle includes injecting a first fluid through first ports in a first rotational direction, injecting a second fluid through second ports in a second rotational direction, and injecting a third fluid through third ports in a third rotational direction. The method further includes selecting the first, second, and third fluids from the group consisting of a first fuel, a second fuel, a diluent, and a compressed working fluid.

### FIELD OF THE INVENTION

The present invention generally involves an apparatus and method for supplying fuel. Specifically, the present invention includes a counter-swirling nozzle that may be used with a combustor in a gas turbine.

### BACKGROUND OF THE INVENTION

Gas turbines are widely used in commercial operations for power generation. It is widely known that the thermodynamic efficiency of a gas turbine increases as the operating temperature, namely the combustion gas temperature, increases. Higher temperature combustion gases contain more energy and produce more work as the combustion gases expand in the turbine. However, higher combustion temperatures often produce localized hot spots in the combustors, particularly along the combustor liners. The localized hot spots may increase wear along the liners, requiring more frequent inspections of the liners. In addition, higher combustion temperatures increase the generation of NOx which is an undesirable exhaust emission.

A variety of techniques exist to allow increased combustion temperatures while minimizing localized hot spots and undesirable emissions. For example, steam may be injected into the combustor to reduce the combustor flame temperature, thereby reducing or eliminating the production of NOx. However, steam injection requires additional and costly equipment.

The need exists for continued improvement in supplying fuel to a combustor. Ideally, the apparatus and method for supplying fuel will improve the uniformity of the fuel mixture to allow for more complete combustion of the fuel without producing hot spots in the combustor that lead to undesirable emissions.

### BRIEF DESCRIPTION OF THE INVENTION

Aspects and advantages of the invention are set forth below in the following description, or may be obvious from the description, or may be learned through practice of the invention.

One embodiment of the present invention is a nozzle. The nozzle includes a first plurality of ports angled to direct a first fluid in a first rotational direction, a second plurality of ports disposed around the first plurality of ports and angled to direct a second fluid in a second rotational direction; and a third plurality of ports disposed around the second plurality of ports and angled to direct a third fluid in a third rotational direction. The first, second, and third fluids are selected from the group consisting of a first fuel, a second fuel, a diluent, and a compressed working fluid.

Another embodiment of the present invention is a combustor that includes a liner peripherally surrounding a portion of the combustor to define a combustion chamber and a nozzle located at one end of the liner. Primary ports are disposed in the nozzle and angled to inject a first fuel in a first rotational direction. Secondary ports are disposed around the primary ports and angled to inject a second fuel in a second rotational direction, wherein the second rotational direction is opposite the first rotational direction. Tertiary ports are disposed around the second plurality of ports and angled to inject at least one of a diluent or a compressed working fluid in a third rotational direction, wherein the third rotational direction is opposite the second rotational direction.

The present invention also includes a method for supplying fuel through a nozzle. The method includes injecting a first fluid through a first plurality of ports in a first rotational direction, injecting a second fluid through a second plurality of ports in a second rotational direction, and injecting a third fluid through a third plurality of ports in a third rotational direction. The method further includes selecting the first, second, and third fluids from the group consisting of a first fuel, a second fuel, a diluent, and a compressed working fluid.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section a gas turbine within the scope of the present invention;

FIG. 2 is a simplified cross-section of the combustor shown in FIG. 1;

FIG. 3 is a perspective view of a nozzle assembly shown in FIG. 2;

FIG. 4 is an exploded perspective view of one of the nozzles shown in FIG. 3; and

FIGS. 5, 6, and 7 are simplified illustrations of alternate embodiments of the primary, secondary, and tertiary ports within the scope of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

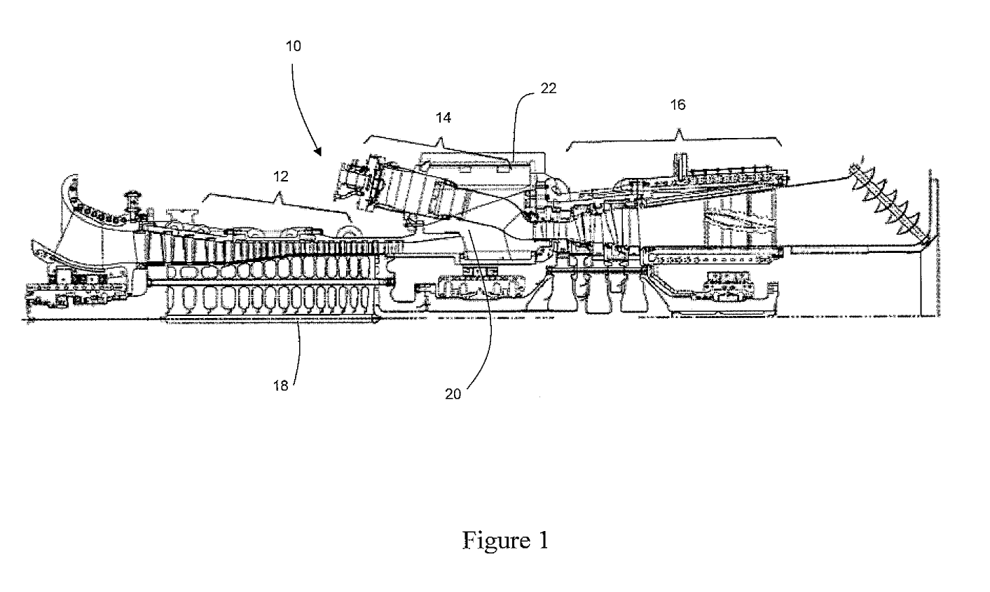

FIG. 1 shows a typical gas turbine 10 within the scope of the present invention. The gas turbine 10 includes a compressor 12 at the front, one or more combustors 14 around the middle, and a turbine 16 at the rear. The compressor 12 and the turbine 16 typically share a common rotor 18. The compressor 12 imparts kinetic energy to the working fluid (air) to bring it to a highly energized state. The compressed working fluid exits the compressor 12 and flows to a plenum 20 downstream of each combustor 14.

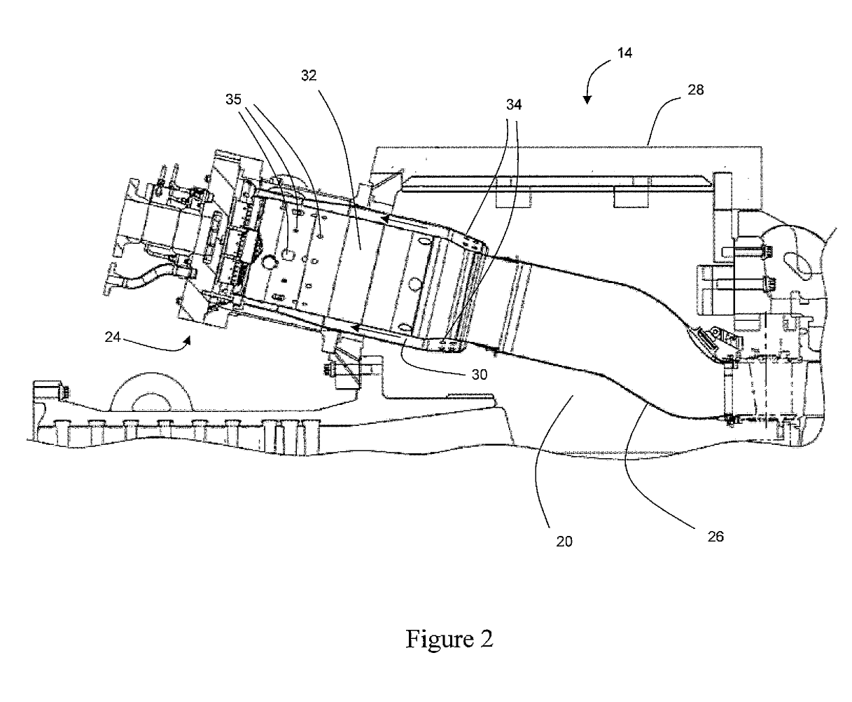

Referring to FIG. 2, each combustor 14 includes a nozzle assembly 24 at one end and a transition piece 26 at the other end. A casing 28 surrounds each combustor 14 to contain the compressed working fluid in the plenum 20. A shroud or liner 30 inside the casing 28 peripherally surrounds a portion of each combustor 14 to define a chamber 32 in each combustor 14. The compressed working fluid exits the plenum 20, enters through dilution holes 34, and travels along the outside of the liner 30 (as shown by the arrows) to cool the liner 30. A portion of the compressed working fluid enters the chamber 32 through mixing holes 35, and the remainder of the compressed working fluid enters the chamber 32 through the nozzle assembly 24.

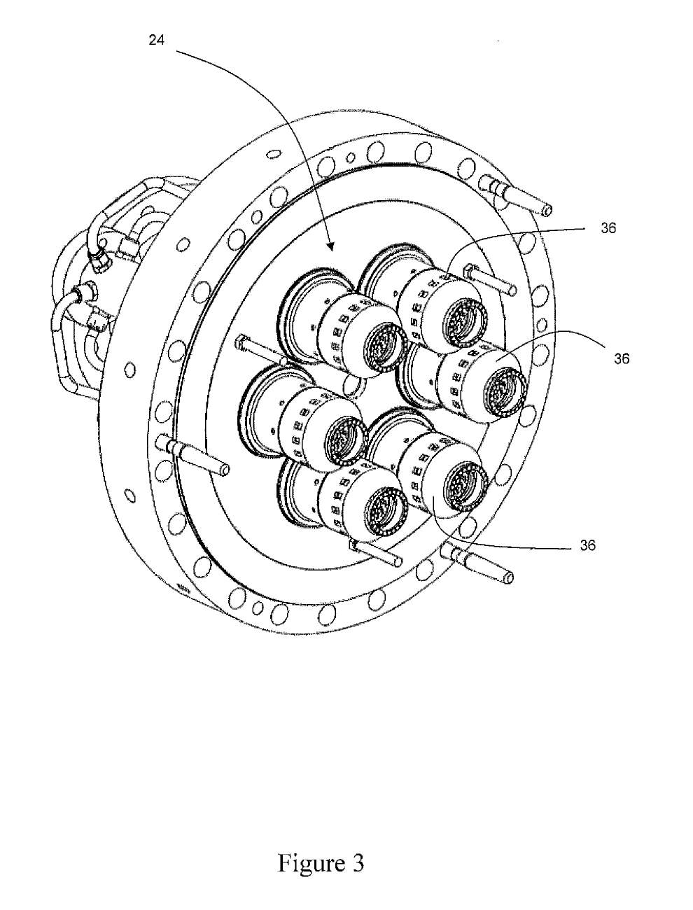

FIG. 3 provides a perspective view of the nozzle assembly 24 shown in FIG. 2. Each nozzle assembly 24 includes one or more nozzles 36 that mix fuel with the compressed working fluid. The mixture of fuel and working fluid ignites in the chamber 32 to generate combustion gases having a high temperature, pressure, and velocity. The combustion gases flow through the transition piece 26 to the turbine 16 where they expand to produce work.

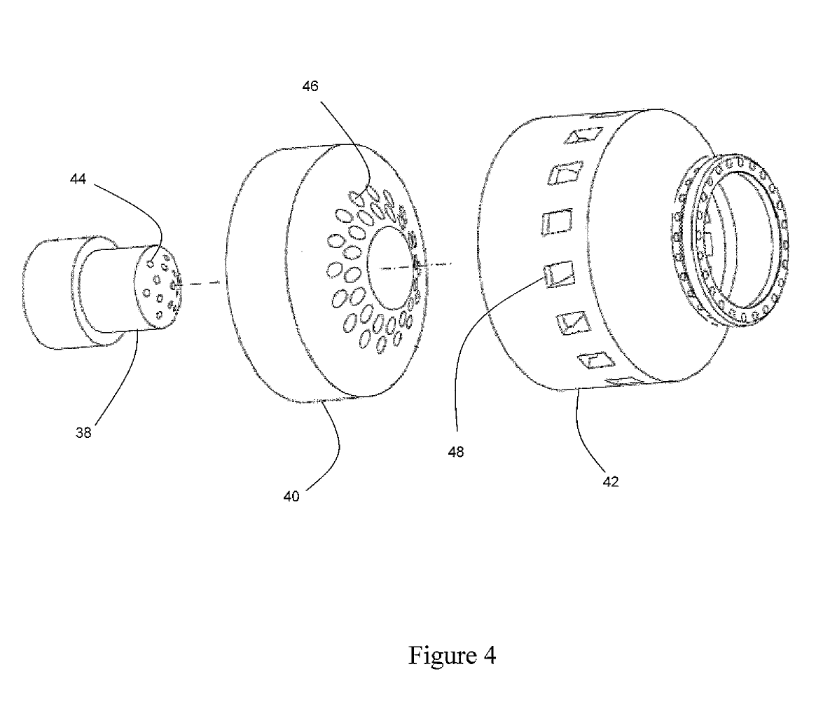

FIG. 4 provides an exploded perspective view of one of the nozzles 36 shown in FIG. 3. As shown, each nozzle 36 includes generally concentric primary 38, secondary 40, and tertiary 42 assemblies that channel the fuel, a diluent, and/or compressed working fluid together. In alternate embodiments within the scope of the present invention, the primary, secondary, and tertiary assemblies may be constructed as a single piece instead of separate assemblies.

The primary assembly 38 is located in the center of the nozzle 36 and includes a first plurality of ports or primary ports 44. The primary ports 44 include passages through which a fluid, such as a first fuel, diluent, and/or compressed working fluid, flows. The primary ports 44 are angled to inject the fluid into the combustion chamber 32 in a first rotational (i.e., clockwise or counter-clockwise) direction.

The secondary assembly 40 is disposed around the primary ports 44 and includes a second plurality of ports or secondary ports 46. The secondary ports 46 include passages through which a fluid, such as a second fuel, diluent, and/or compressed working fluid, flows. The secondary ports 46 are angled to inject the fluid into the combustion chamber 32 in a second rotational (i.e., counter-clockwise or clockwise) direction. The second rotational direction may be the same as or opposite to the first rotational direction.

The tertiary assembly 42 is disposed around the secondary ports 46 and includes a third plurality of ports or tertiary ports 48. The tertiary ports 48 include passages through which a fluid, such as a first fuel, second fuel, diluent, and/or compressed working fluid flows. The tertiary ports 48 are angled to inject the fluid into the combustion chamber 32 in a third rotational (i.e., counter-clockwise or clockwise) direction. The third rotational direction may be the same as or opposite to the second rotational direction.

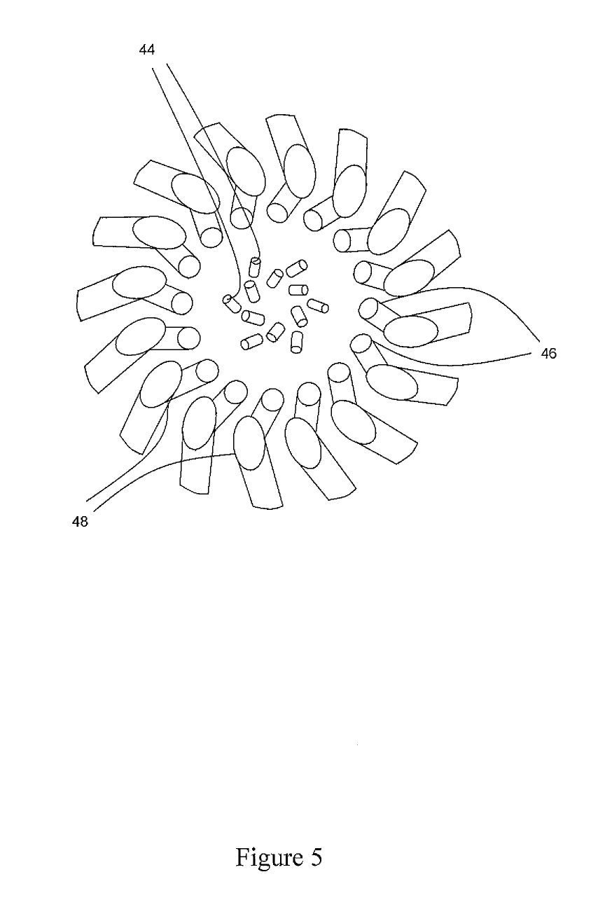

FIGS. 5, 6, and 7 provide simplified illustrations of the primary 44, secondary 46, and tertiary 48 ports arranged according to alternate embodiments within the scope of the present invention. In each embodiment, the primary 44, secondary 46, and tertiary 48 ports may be used to inject various combinations of the first fuel, second fuel, diluent and/or compressed working fluid into the combustion chamber 32. The first and second fuels may be any liquid or gaseous fuel suitable for combustion. Possible fuels used by commercial combustion engines include, for example, blast furnace gas, coke oven gas, natural gas, vaporized liquefied natural gas (LNG), propane, and hydrogen. The actual fuels used varies according to several operational factors, such as the desired heating value, availability, cost, etc. Although the present invention has been described with respect to first and second fuels, alternate embodiments within the scope of the present invention may use the same fuel as both the first and second fuel. The diluent may be any fluid used to dilute fuel, such as steam, air, and water. The compressed working fluid may be the compressed air or other fluid provided by the compressor 12 or other source.

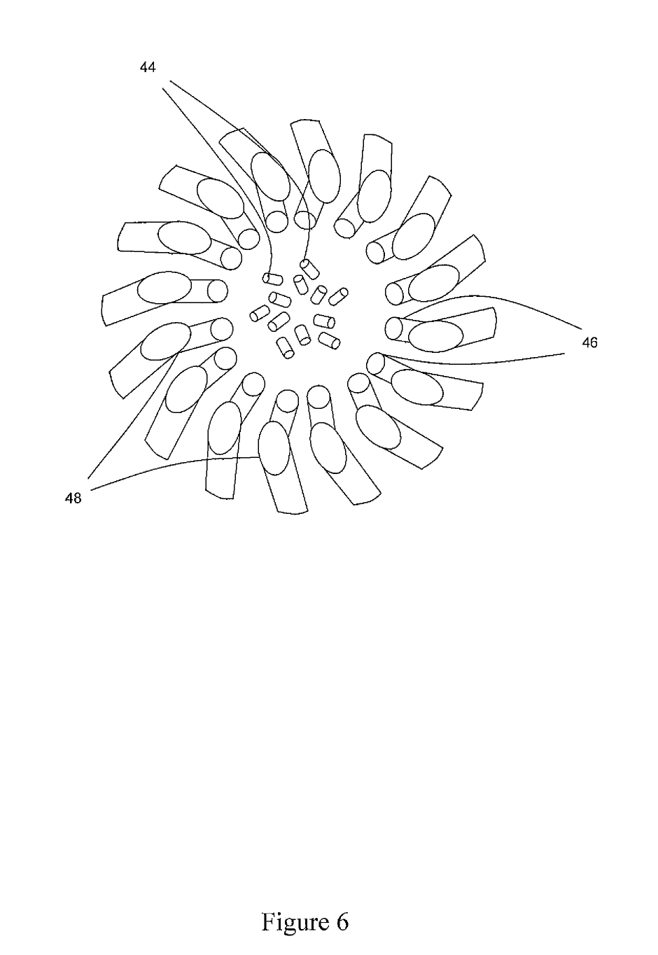

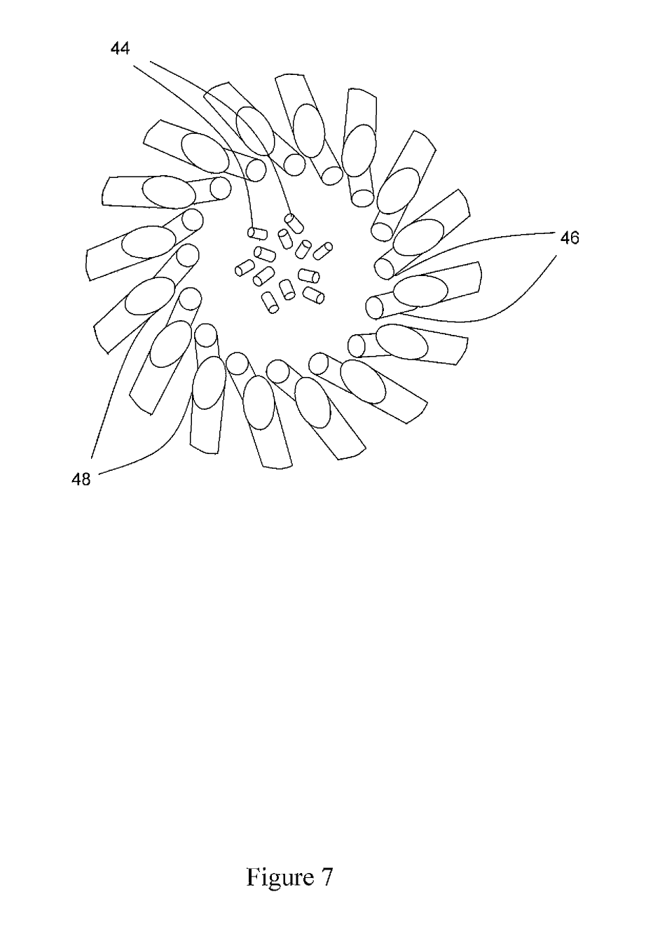

In the embodiment shown in FIG. 5, the primary ports 44 are arranged in a slightly askew circular pattern and angled to impart a clockwise rotation to the fuel, diluent, and/or compressed working fluid. The secondary ports 46 are arranged in a circular pattern and angled to impart a counter-clockwise rotation to the fuel, diluent, and/or compressed working fluid. The tertiary ports 48 are arranged in a circular pattern and angled to impart a clockwise rotation to the fuel, diluent, and/or compressed working fluid. The embodiment shown in FIG. 6 has primary 44 and secondary 46 ports angled in the same counter-clockwise direction, while the tertiary ports 48 are angled in the opposite clockwise direction. FIG. 7 shows an embodiment in which the secondary 46 and tertiary 48 ports are angled in the same clockwise direction, and the primary ports 44 are angled in the opposite counter-clockwise direction.

The angle of the primary 44, secondary 46, and tertiary 48 ports depends on several variables unique to each particular application. For example, ports angled closer to a line tangent to the nozzle perimeter impart more rotation to the injected fluid, but the injected fluid penetrates a shorter distance radially. Conversely, ports angled away from a line tangent to the nozzle perimeter impart less rotation to the injected fluid, but the injected fluid penetrates a greater distance radially.

Similarly, the size, number, and flow rate through the primary 44, secondary 46, and tertiary ports 48 may be selected according to the desired design goals. For example, the design goals may require that the first and second fuels provide a specific heating value for combustion. The size, number, and flow rate for the primary 44 and secondary 46 ports may thus be selected to achieve the desired heating value.

Computational fluid dynamic modeling has been performed to demonstrate the performance of nozzles and combustors falling within the scope of the present invention. A comparison was made between a baseline model, in which the fuel and diluent swirl in the same direction, and nozzles and combustors constructed according to embodiments of the present invention, in which the fuel and diluent swirl in opposite directions. The modeling indicates reduced carbon monoxide, indicative of fuel, near the combustion liner for the nozzles and combustors constructed according to embodiments of the present invention. The reduced carbon monoxide near the combustion liner is attributed to the counter rotational flow of the fuel and diluent which produced low swirling fluid exiting the nozzle into the combustion chamber. In addition, the modeling indicates that nozzles and combustors made according to embodiments of the present invention may reduce the combustion liner temperature by approximately 100 to 400 degrees Fahrenheit compared to the baseline model.

It should be appreciated by those skilled in the art that modifications and variations can be made to the embodiments of the invention set forth herein without departing from the scope and spirit of the invention as set forth in the appended claims and their equivalents.

What is claimed is:

1. A nozzle, comprising:
a. a first plurality of ports angled to direct a first fluid in a first rotational direction;
b. a second plurality of ports disposed around the first plurality of ports and angled to direct a second fluid in a second rotational direction; and
c. a third plurality of ports disposed around the second plurality of ports and angled to direct a third fluid in a third rotational direction;
d. wherein the first, second, and third fluids are selected from the group consisting of a first fuel, a second fuel, a diluent, and a compressed working fluid.

2. The nozzle of claim 1, wherein the second rotational direction is opposite the first rotational direction.

3. The nozzle of claim 2, wherein the third rotational direction is the same as the first rotational direction.

4. The nozzle of claim 2, wherein the third rotational direction is the same as the second rotational direction.

5. The nozzle of claim 1, wherein the second rotational direction is the same as the first rotational direction.

6. The nozzle of claim 5, wherein the third rotational direction is opposite the second rotational direction.

7. The nozzle of claim 1, wherein the first plurality of ports inject a higher volumetric flow rate than the second plurality of ports.

8. A combustor, comprising:
a. a liner peripherally surrounding a portion of the combustor to define a combustion chamber;
b. a nozzle located at one end of the liner;
c. primary ports disposed in the nozzle and angled to inject a first fuel in a first rotational direction;
d. secondary ports disposed around the primary ports and angled to inject a second fuel in a second rotational direction, wherein the second rotational direction is opposite the first rotational direction; and
e. tertiary ports disposed around the second plurality of ports and angled to inject at least one of a diluent or a compressed working fluid in a third rotational direction, wherein the third rotational direction is opposite the second rotational direction.

9. The combustor of claim 8, wherein the first fuel is identical to the second fuel.

10. The combustor of claim 8, wherein the primary ports inject a higher volumetric flow rate than the secondary ports.

11. The combustor of claim 8, wherein at least one of the primary or secondary ports are arranged in a circle.

12. The combustor of claim 8, further including a plurality of nozzles.

13. A method for supplying fuel through a nozzle, comprising:
a. injecting a first fluid through a first plurality of ports in a first rotational direction;
b. injecting a second fluid through a second plurality of ports in a second rotational direction;
c. injecting a third fluid through a third plurality of ports in a third rotational direction; and
d. selecting the first, second, and third fluids from the group consisting of a first fuel, a second fuel, a diluent, and a compressed working fluid.

14. The method of claim 13, wherein the second rotational direction is opposite the first rotational direction.

15. The method of claim 14, wherein the third rotational direction is the same as the first rotational direction.

16. The method of claim 13, wherein the second rotational direction is the same as the first rotational direction.

17. The method of claim 13, further including injecting a higher volumetric flow rate of the first fuel than the second fuel.
